(19) United States
(12) Patent Application Publication
(10) Pub. No.: US 2016/0284032 A1
(43) Pub. Date: Sep. 29, 2016

(54) Method for Distributed Manufacturing

(71) Applicant: The Procter & Gamble Company, Cincinnati, OH (US)

(72) Inventors: Charles John Berg, JR., Wyoming, OH (US); Michael Sean Farrell, Terrace Park, OH (US); David Kent Mattheis, West Chester, OH (US)

(21) Appl. No.: 15/075,239

(22) Filed: Mar. 21, 2016

Related U.S. Application Data
(60) Provisional application No. 62/138,416, filed on Mar. 26, 2015.

(51) Int. Cl. G06Q 50/04; G06Q 30/02; G05B 19/408; G06Q 50/18

(52) U.S. Cl. CPC G06Q 50/04; G06Q 50/184; G06Q 30/02; G05B 19/408; G05B 2219/34376

(57) ABSTRACT

A method for the distributed manufacturing of an object includes steps of: providing one or more data files for at least one object associated with a branded product and/or service; including the object, images of the object, and/or references to the object, in marketing materials for the branded product or service; providing access to the one or more files via a network in exchange for traffic to a network location associated with the branded product and/or service; and having the objects manufactured using the one or more files accessed over the network.

### FIELD OF THE INVENTION

The invention relates to the distributed manufacturing of objects. The method relates particularly to the distributed manufacturing of objects in association with the sales and marketing of a product and/or service.

### BACKGROUND OF THE INVENTION

One known aspect of the marketing of branded product and services is the effort to share the story of the product and/or service in a manner which resonates with the target consumers. Objects and imagery ancillary to the actual product and/or service may be used in the sharing of this story. Such ancillary objects may alter or improve the use and/or enjoyment of the actual product or service, —and/or may assist in the telling of the story and may become an element of the fabric of the story. This in turn may lead to, and drive, consumer desire to acquire such objects. Consumers having a strong desire to identify themselves with particular brands may wish to acquire objects representing such brands, while not using or owning the actual branded products or services. Such objects may exist as designs and in limited quantities as objects for use in marketing campaigns, but not in quantities relevant to the market demand.

The manufacturing of such objects may be beyond the current business of the product manufacturer and/or service provider and there may not be sufficient interest on the part of the manufacturer/service provide to lead to the production of market relevant quantities of the objects. The costs associated with the production of such objects and imagery may render any desire to procure them in sufficient quantities to make them a part of the general consumer experience associated with the product and/or service moot. However, some consumers may be willing to undertake the cost of producing the object via a distributed manufacturing method.

Similarly, complex, multi-component product compositions may be withheld from the market solely for want of an economical dispensing system, as the necessary complexity of the dispensing system renders the cost of such a system prohibitive.

What is needed is a method for the efficient provision of such objects to those consumers having a desire to acquire them.

### SUMMARY OF THE INVENTION

In one aspect, a method for the distributed manufacturing of an object, the method including steps of: providing one or more data files for at least one object associated with a branded product and/or service; including the object, images of the object, and/or references to the object, in marketing materials for the branded product or service; providing access to the one or more files via a network in exchange for traffic to a network location associated with the branded product and/or service; and having the objects manufactured using the one or more files accessed over the network.

### DETAILED DESCRIPTION OF THE INVENTION

All listings of elements should be considered as exemplary and non-limiting in nature.

As used herein, the term product means: any tangible product which may serve as an article of commerce, including: consumable products, durable products, and software products.

As used herein, service means: any and all services which may form the basis for transactions in commerce, including: entertainment services, broadcast services, services performed in person, and software as a service.

As used herein, the term data file means: any formatted collection of data associated with or describing an object or article. The data file may be in any format suitable for use by a digitally controlled manufacturing element such as a 3D printer, a CNC unit, a laser cutting system, or other systems adapted to translate digital files into physical objects. Exemplary file formats include: .STL, .OBJ, G-code, SVG files, .dxf files, and other file formats as described in ASTM F2792.

As used herein, the term branded means: associated with, or belonging to a particular brand name used in commerce.

As used herein the term indicia means: any and all visual elements carrying meaning when viewed and/or textural elements carrying meaning when felt or touched. Indicia may include: textual and graphical and textural elements which may or may not be associated with the brand including the brand name or subnomen, as well as any iconic images or patterns associated with the brand, product information, use instructions, product or service use statements, dietary or nutritional information, or a sentiment directed toward the consumer or the consumer's experience with the product or service such as by example “Enjoy”, etc.

As used herein, the term lifecycle means: the set of events and activities associated with the product and/or service from beginning to end. Lifecycle includes: raw materials, manufacture, distribution, sale, use, and ultimate disposal as well as service requests, performance and follow-up activities.

As used herein, the term network includes: electronic networks and digital networks supporting the transfer of digital information. A network may comprise: network sites such as websites; network pages such as web pages; cloud service, an internet; an intranet; electronic or digital marketplaces or collections.

As used herein, marketing materials include: print media, including posters, circulated paper-based media, mailers, flags & banners, handbills, clothing, labels, billboards; television advertisements; radio advertisements; still or streaming content (advertisements) over a network to a consumer; packaging associated with a product; inserts including those associated with a (physical) product.

In one aspect, the method for the distributed manufacturing of an object includes steps of: providing one or more data files for at least one object associated with a branded product and/or service; including the object, images of the object, and/or references to the object, in marketing materials for the branded product or service; providing access to the one or more files via a network; having the objects manufactured using the one or more files accessed over the network. The files may be provided by a marketing entity, a manufacturer or distributor of the associated product, a service provider of an associated service, an intermediary third party acting on behalf of any of the entities set forth above, and combinations of these entities. The files may be provided via multiple file provision channels including multiple web sites available via the internet, and may further be provided via correspondence through tradition mail systems wherein a requestor may make a request, either over a network, by telephone, or in writing via a traditional mail service, and the request may be fulfilled via mail over a network. Files provided via a mail service may be provided as a disk or other non-transitory electronic media form. An intermediary, such as Shapeways® or Thingiverse®, may provide a marketplace for access to the data files over the internet.

In one embodiment, the file(s) may be provided via a dedicated application, or app, provided for the purpose of facilitating access to the files by the provider. The app may also include further marketing elements associated with the branded product or service. In some embodiments, the app may include executable software enabling a user to view the object of the data files and in some instance, to edit the appearance of the object prior to manufacturing the object. The use may alter the color, finish, or other aspects of the objects appearance, or may add or delete visual elements such as text or indicia.

In one embodiment, a product, which has the non-transitory storage capacity, the necessary data files may be incorporated within the product and provided at the discretion and control of the manufacturer—e.g. a computer game provided via a DVD could include the necessary files associated with the objects of desire and upon achievement of the necessary elements, the files may be unlocked and made available. Similarly, and product having sufficient memory capacity may be provided with the requisite files—a phone may include accessory items such as a stand or case within the memory of the phone, or via a link provided with the phone to a network location of the files. For products generally bereft of electronic storage media, such media may be provided together with the product—such as by providing a usb flash drive, an SD memory card, a CD or DVD with the product.

In one embodiment, the media may be provided to a user independent of the product. Examples of such an embodiment include: delivering a usb flash drive to the residence or office of the user at her request, or not at her request; or, providing a CD to the user in person, solicited or unsolicited, away from the user's office or residence such as at a store, mall or plaza, park, school, university campus, sporting event location, convention meeting, or entertainment or show venue.

The consumer may acquire, such as ordering and having the object produced, without possessing the associated product or using the associate service. In such situations, the consumer may intend to provide the object to an acquaintance, or to sell it, or prepare for the use of the associated product or service, or use the object with an alternate product or service even though this may not meet the wishes of the product manufacturer and/or service provider. The product manufacturer and/or service provider may offer the object's one or more data files to encourage the purchase and/or use of its product and/or service.

The object may be associated with a branded product and/or service. Exemplary objects include: accessories for consumer goods, a stand for a razor, a toothbrush holder, a cover for tissues or air freshening products, a carrying case for individual personal care items such as cosmetics, medications, hygienic articles including disposable absorbent and cleaning articles, product proportioning elements such as a scoop or other product measuring element, a tube-squeezer to facilitate the dispensing of a product such as toothpaste, from a tube; coaster for a beverage container; bowl for a salted snack; cup or mug for a ready to drink or a prepared beverage; a cup or container for a laundry aid product. Such consumer goods may be single or limited-use (consumable); and, may be disposable. In some embodiments, the consumer good may be a durable good. Exemplary objects may be associated with one or more attributes of the product and/or service selected from the group consisting of: the storage of the product, the use of the product and/or service, a sale promotion, sampling or marketing campaign of the product and/or service, and combinations thereof. The object may be re-usable for a significant number of associated product or service uses or experiences, including being re-applied to a different unit of the product (e.g. a fresh tube of dentifrice after the previous one has been emptied; a snap-on or screw-on lid for covering a fresh container after the previous one has been emptied of the product contained within comprising, for example: creams, lotions, medicaments, powders, granules, gels, liquid formulations, foodstuffs, beverages, gels, sauces, soda, emulsions, etc.

Objects associated with a service may include mascots or other iconic objects relating to sports or entertainment entities. Objects associated with particular sports and including the brand name of entities may be provided, e.g. a baseball, football, basketball, tennis ball, and hockey puck, shaped object incorporating the name and or logo of a particular team or individual player of the respective sport. In one embodiment, the objects may be related to software products and services including on-disk or on-line game services. In this embodiment, the object may be the personal avatar of a player of the game, or a non-player character (NPC) from the game. The object may also be an accessory compatible and associated with such an avatar, accessory game item, or NPC. The method may include allowing a user to download and manufacture an avatar, accessory game item, or NPC together with the associated game items for the avatar or NPC e.g. weapons, armor. The method includes making such object data files immediately available to a user, also making such files available upon receipt from the user of funds associated with an in-game purchase, or upon completion of a particular task, or in the case of accessories, acquisition of the corresponding accessory within the game. Such objects may include a serial number associating the object with a particular user/player and differentiating each object from all others. Objects associated with entertainment programming, television, film, and internet video, may be made available for manufacture via marketing materials associated with the programming.

In each of the respective embodiments set forth, the object may incorporate indicia associated with a particular brand. Exemplary indicia include the brand name, and iconic images of characters, mascots, or other imagery associated with the brand. Exemplary indicia include: the Nike® Swoosh®, Mr. Pringles®, and Mr. Peanut®. The brand name may be incorporated in the forms associated with the product, e.g. a script Coca-Cola®, Charmin®, Crest®, Bounty®, Pantene®, Oral B®, and the crest of the National Football League®.

In one embodiment, the indicia may be associated with the branded product lifecycle and may include pictorial or textual instructions regarding the use, and/or disposal of the branded product in conjunction with, or apart from the object of the data file.

The marketing materials may include reference to the objects and the availability of the associated data files. The messaging may include the objects and images of the objects. The messaging may include reference to, or a depiction of, the act of manufacturing the object in a manner relating that act to an aspect of the branded product or the target demographic of the branded product. Alternatively, the marketing materials associated with systems for manufacturing may refer to the availability of data files from the file provider and also to the marketing materials of the data file provider.

The data files may be provided with no further action from the user other than the network traffic to the download site for the purpose of downloading the file. In one embodiment, the data files may be made available in exchange for the user registering at a site and providing information as part of the registration process. In one embodiment, proof of purchase of an associated product or service may be required in association with the downloading of the file or as a prerequisite to such downloading. Acceptance of license terms and conditions controlling and/or limiting the use of the data file, and associated object, may be required as a prerequisite to access of the file. Explicit offers to license the object may be presented as an option for access to the data file(s).

As noted above, in one embodiment, a game player may be required to complete a task in order to unlock the availability of the desired file, or upon completion of a task, may be made aware of the availability of an associated data file. In such an embodiment, the provider of the data files may provide a means for a registered user to designate a system memory location, a cloud account location or a network accessible address—e.g. email address, or social media account address where earned or unlocked files may be transferred. In such an embodiment, the world of the game may include an in game marketplace for the acquisition of file access, or the codes associated with file access may be part of the in-game experience associated with acquiring an item or accomplishing a particular task associated with a particular object data file.

Once a user has downloaded the data file, any appropriate manufacturing system may be used to manufacture the object from the provided file. Exemplary systems include: 3D printers using additive manufacturing systems for thermoplastic materials, or sintering systems for plastic or metal materials, often starting in a powdered state.

Users of the data file and/or the third party object provisioning service may be encouraged to submit images of their completed object for acceptance and display by the file provider, marketer or third party provisioner for further marketing the branded product and/or the third party provisioning service.

Users may be encouraged or incentivized to provide video or still images, of the manufactured object, staged in a creative manner or against backgrounds providing a humorous or thought-provoking context either in isolation or when taken as a collection of images. The provided images may then be displayed by the recipient at a website or a social media location, or in print or broadcast marketing messaging. The owner, manufacturer or distributor for the brand may host or display one or more of the recipient's images.

In one embodiment, the method may include the provision of a plurality of data files associated with a plurality or collection or array of a collection of objects which may be related objects. Among the plurality of data files, at least one and sometimes just one of the data files is necessary for the distributed manufacturing for each of at least two objects of the collection. The objects of the collection may all be related to a single branded product and/or service—such as a collection of characters from a game, film, or television program, or a collection of accessory items for a consumer good such as various accessory items for a Swiffer® floor cleaning implement. Alternatively, the collection members may each be associated with a separate but related product and/or service.

A manufacturer may provide a set of elements, each element associated with a unique branded product, but presented as a collection of objects having a design relationship tying each to the others. As another example, member teams of a particular sports league may each provide an element to the collection wherein the set of elements has particular design attributes which carry across the entire collection or wherein each member element stands as a unique offering and the only connection lies in the league association. In such an embodiment, the common elements of the collection may be as little as a league identification element depicted as a part of each member element.

In such an embodiment, one or more marketing messages may be presented which include reference to or one or more depictions of portions of the collection in a manner intended to make consumers aware of the existence of the collection and potential relationships between member objects within the collection. In this manner the potential user may be moved to begin collecting the respective collection members. The one or more depictions may be an arrangement of a plurality of objects from the collection of objects.

The respective members of the collection may be bound to a particular brand name and may be further differentiated in terms of events or calendar seasons. E.g.: holiday themed members, each associated with the same product but a different holiday. Seasonal members, again, sharing a product association but differentiated by calendar season.

The method of the invention may further include the provision of data files associated with semi-durable or durable items for use with particular embodiments of branded products. As an example, a particular cleaning product may comprise a product formulation having multiple component chemical portions. The reactive nature of the respective portions may necessitate that the portions be combined immediately prior to use to ensure efficacious performance. Such just-in-time component combination may in turn require a dispensing system which is not possible at the market value the product is capable of commanding. An alternative available via the method of the invention is to provide consumers with the option of manufacturing the dispensing system by downloading the requisite data file or files and manufacturing the item(s). In this manner, the component chemistry portions may be made available for use in a self-manufactured dispensing element.

In one embodiment, the logic associated with a portion of the steps of the invention may reside, or be provided in the form of a non-transitory computer-readable medium comprising logic for performing distributed manufacturing. The logic, when executed by a computing device, causes the computing device to perform at least the following: provide one or more data files for at least one object associated with a branded product and/or service; include the object, images of the object, and/or references to the object, in marketing materials for the branded product or service; and provide access to the one or more files via a network in exchange for traffic to a network location associated with the branded product and/or service.

In a prophetic example, Crest® brand toothpaste may originate a multi-dimensional marketing campaign to raise awareness of a new or existing sub-brand, e.g. a new whitening version of Crest®. The campaign may have elements across television, print, radio, mobile apps and the internet. The elements may also include rapid response elements such as a QR code to facilitate target consumer responses. The campaign may include mention of, or use of a non-product object, such as a plurality of Crest® marked tube squeezing implements, or a Crest® marked toothbrush holder. Objects which may contact the product or the product package during use. The implements may be made available to consumers, not as objects themselves, but as data files for acquisition by the consumer for subsequent manufacture, by the consumer, or under the control or request of the consumer. A plurality of the objects may be arrayed in the images of the marketing campaign, such as in a printed ad, or at the website associated with the brand and campaign. Various versions of the objects may be made available as distinct data files, each version differentiated according to an aspect unrelated to the brand, such as the season of the year, or well known holidays or other events. The objects may further incorporate product associated information relevant to the Crest® products themselves, such as the brand name or subnomem, a contact phone number or URL address, usage instruction, or one or more ingredients. The campaign elements may include various means for acquiring the necessary data files: web addresses where the files may be downloaded can be provided directly, or via the rapid response (QR) code. Direct links to a downloadable file may be provided by the complete text of the linked address, or by a print copy including the address or a QR code linked to the address. The plurality of Crest® marked tube squeezing implements, or a Crest® marked toothbrush holder, once produced, may include one or materials such as those comprising polymers, plastics, thermosets and metals. The object may be associated with a dentifrice tube with a screw cap dispenser—wherein the object may be a larger diameter cap (or a cap with a gripping element such as protrusions on the outside of the cap) that possesses the matching internal thread pattern so that it can be substituted for the dentifrice manufacturer's supplied cap.

The substituted cap may comprise a decorative design either associated with the brand, with a well known character, a holiday or season, or other concept easily depicted as an object.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for the distributed manufacturing of an object, the method comprising steps of:
a. providing one or more data files for at least one object associated with a branded product and/or service;
b. including the object, images of the object, and/or references to the object, in marketing materials for the branded product or service;
c. providing access to the one or more files via a network; and
d. having the object manufactured using the one or more files accessed over the network.

2. The method according to claim 1, wherein the at least one object is associated with one or more attribute of the product and/or service selected from the group consisting of: the storage of the product, the use of the product and/or service, a marketing campaign of the product and/or service, and combinations thereof.

3. The method according to claim 1, wherein the object embodies indicia associated with the product and/or service.

4. The method according to claim 1 further comprising the step of offering a license for the manufacturing, use and/or sale of the object.

5. The method according to claim 1 wherein the association of the object with the product includes contact of the object with the product during the product's lifecycle.

6. The method according to claim 1 wherein the object comprises indicia associated with an aspect of the lifecycle of the product and/or service.

7. The method according to claim 1 further comprising the step of accepting, via a network, one or more images of manufactured objects.

8. The method according to claim 7 further comprising the step of displaying, via a network, the accepted images of one or more manufactured objects.

9. The method according to claim 1 wherein one or both of the steps of: providing access to the one or more files via a network; and having the one or more objects manufactured using the one or more files accessed over the network are completed by a third party.

10. The method according to claim 1 further comprising providing data files associated with a collection of objects.

11. The method according to claim 10 further comprising presenting one or more marketing messages including an array of the collection of objects or a depiction of an arrangement of a plurality of objects from the collection of objects.

12. The method according to claim 10 wherein a first object of the collection is associated with a first product and/or service and a second object of the collection is associated with a second product and/or service distinct from the first product and/or service.

13. The method according to claim 10 wherein a first object of the collection is associated with a first event and a second object of the collection is associated with a second event distinct from the first event.

14. The method according to claim 10 wherein a first object of the collection is associated with a first service provider and a second object of the collection is associated with a second service provider.

15. The method according to claim 1 wherein the step of having the object manufactured comprises having the object manufactured using a digitally controlled apparatus.

16. The method according to claim 1 further comprising the step of associating the manufacturing of the one or more accessed data files with one or more of the marketing materials.

17. The method according to claim 1 further comprising the step of associating the product with the manufacturing of the object with the one or more accessed data files.

18. The method according to claim 1 wherein the object is associated with the dispensing of a multi-part product composition.

19. The method according to claim 1 further comprising the step of receiving information associated with a product or service prior to providing access to the one or more data files.

20. A non-transitory computer-readable medium for performing distributed manufacturing that includes logic, that when executed by a computing device, causes the computing device to perform at least the following:
a. providing one or more data files for at least one object associated with a branded product and/or service;
b. including the object, one or more images of the object, and/or references to the object, in marketing materials for the branded product or service; and
c. providing access to the one or more files via a network in exchange for traffic to a network location associated with the branded product and/or service.
